(19) United States
(12) Patent Application Publication
(10) Pub. No.: US 2025/0297179 A1
(43) Pub. Date: Sep. 25, 2025

(54) PIPE IN GASIFICATION SYSTEM, GASIFICATION SYSTEM AND METHOD FOR PRODUCING SYNTHESIS GAS USING THE SAME, AND FUEL PRODUCTION SYSTEM AND METHOD FOR PRODUCING LIQUID FUEL USING THE SAME

(71) Applicant: HONDA MOTOR CO., LTD., Tokyo (JP)

(72) Inventors: Akira Sonoda, Wako-shi (JP); Kota Okamura, Wako-shi (JP); Shiori Nakajima, Wako-shi (JP)

(21) Appl. No.: 19/053,487

(22) Filed: Feb. 14, 2025

(30) Foreign Application Priority Data
Mar. 21, 2024 (JP) 2024-045533

(51) Int. Cl. C10J 3/76; B01J 6/00; C01B 3/02; C10J 3/72

(52) U.S. Cl. CPC C10J 3/76; B01J 6/008; C01B 3/02; C10J 3/723; C10J 2200/152

(57) ABSTRACT

There is provided a pipe through which a biomass raw material supply device for supplying a biomass raw material to a gasification device and a synthesis gas production device including a gasification furnace for gasifying the biomass raw material to produce a synthesis gas communicate with each other, the synthesis gas production device including a gasification furnace temperature measuring unit for measuring a temperature of an upper end portion of the gasification furnace, the pipe including: a pipe temperature measuring unit for measuring a temperature inside the pipe; and a pipe cooling unit for cooling at least a part of the pipe.

### CROSS-REFERENCE TO RELATED APPLICATION

Priority is claimed on Japanese Patent Application No. 2024-045533, filed Mar. 21, 2024, the content of which is incorporated herein by reference.

### BACKGROUND OF THE INVENTION

### Field of the Invention

The present disclosure relates to a pipe in a gasification system, a gasification system and a method for producing a synthesis gas using the same, and a fuel production system and a method for producing a liquid fuel using the same.

### Description of Related Art

In the related art, efforts to mitigate climate change or reduce an impact thereof have continued, and research and development related to reducing carbon dioxide emissions has been performed to achieve this.

In recent years, as an alternative to fossil fuels, synthetic fuels obtained by using hydrogen generated using electric power generated from renewable energy and a carbon source such as carbon dioxide discharged from biomass or factories as raw materials have attracted attention.

A general procedure for producing a liquid fuel such as methanol or gasoline using biomass as a raw material is as follows. That is, the liquid fuel is produced from the biomass raw material through a gasification step of gasifying the biomass raw material, which has undergone a predetermined pretreatment, together with water or oxygen in a gasification furnace to generate a synthesis gas containing hydrogen and carbon monoxide, a cleaning step of cleaning the generated synthesis gas to remove tar, an H₂/CO ratio adjustment step of adjusting an H₂/CO ratio of the synthesis gas, which has undergone the cleaning step, to a target ratio corresponding to a liquid fuel to be produced, a desulfurization step of removing a sulfur component from the synthesis gas, which has undergone the H₂/CO ratio adjustment step, and a fuel production step of producing the liquid fuel from the synthesis gas, which has undergone the desulfurization step.

When the solid biomass raw material is gasified, some of the carbon and hydrogen are combusted. However, when a degree of partial combustion is too low, an amount of non-gaseous combustible substances generated, such as tar, soot, and dust, increases. When the amount of these generated substances increases, a pipe is clogged, and the biomass raw material cannot be supplied. Therefore, a method of reducing the amount of non-gaseous combustible substances generated, such as tar, soot, and dust, is desired.

Japanese Unexamined Patent Application, First Publication No. 2017-193676 discloses an invention for suppressing tar generation by promoting decomposition of hydrocarbons using air, which is activated through contact with an alpha-ray emitting substance, as an oxidative gas, in a step of gasifying a biomass by reacting the biomass with the oxidative gas.

### SUMMARY OF THE INVENTION

In the tar generation suppression method disclosed in Japanese Unexamined Patent Application, First Publication No. 2017-193676, irradiation with alpha rays, for example, contact with a molded body containing thorium, is required, which makes the handling of a radioactive substance difficult and poses safety concerns. In addition, since a device for emitting alpha rays is also required, an amount of energy consumption increases, and there are cost-related issues due to the investment in equipment.

In order to solve the above-described problems, the present application provides a pipe in a gasification system, a gasification system and a method for producing a synthesis gas using the same, and a fuel production system and a method for producing a liquid fuel using the same that are excellent in handling, safe, improve energy efficiency, and can suppress pipe clogging at a low cost. Moreover, it contributes to the mitigation of climate change or the reduction of the impact.

[1] A pipe through which a biomass raw material supply device configured to supply a biomass raw material to a gasification device and a synthesis gas production device including a gasification furnace configured to gasify the biomass raw material to produce a synthesis gas communicate with each other, the synthesis gas production device including a gasification furnace temperature measuring unit for measuring a temperature of an upper end portion of the gasification furnace, the pipe including:
a pipe temperature measuring unit for measuring a temperature inside the pipe (i.e., the interior surrounded by the pipe); and
a pipe cooling unit for cooling at least a part of the pipe.

The pipe of the present disclosure can suppress clogging using the pipe cooling unit that is excellent in handling and safe.

Additionally, since no special reagent or device is required, energy efficiency can be improved, and pipe clogging can be suppressed at a low cost.

[2] The pipe according to [1],
in which the pipe does not have a region with a temperature exceeding 300° C. and lower than 600° C.

Since the pipe of the present disclosure does not have the above-described temperature region, clogging can be suppressed.

[3] The pipe according to [1] or [2],
in which the pipe cooling unit initiates or strengthens cooling of at least a part of the pipe in a case where the temperature inside the pipe exceeds a predetermined value.

In the pipe of the present disclosure, by initiating or strengthening cooling of at least a part of the pipe in a case where the temperature inside the pipe exceeds a predetermined value, pipe clogging is suppressed, and the pipe is prevented from being excessively cooled, making it possible to improve energy efficiency.

[4] The pipe according to [3],
in which the predetermined value is 300° C.

In the pipe of the present disclosure, by initiating or strengthening cooling of at least a part of the pipe in a case where the temperature inside the pipe exceeds 300° C., pipe clogging is suppressed, and the pipe is prevented from being excessively cooled, making it possible to improve energy efficiency.

[5] The pipe according to any one of [1] to [4],
in which the pipe cooling unit includes a cooling gas supply unit for cooling an inside of the pipe by blowing a cooling gas to at least a part of an outside of the pipe to cool the outside of the pipe, and a cooling gas control unit for controlling the cooling gas such that the temperature inside the pipe is 300° C. or lower and the temperature of the upper end portion of the gasification furnace is 600° C. or higher.

In the pipe of the present disclosure, by setting the temperature inside the pipe to 300° C. or lower, pipe clogging is suppressed, and the pipe is prevented from being excessively cooled, making it possible to improve energy efficiency. In addition, by setting the temperature of the upper end portion of the gasification furnace to 600° C. or higher, the gasification reactions of the biomass raw material can proceed more easily. In particular, by employing the above-described configuration in a case of being used in a small-scale gasification device in which the diameter of the gasification furnace is 50 mm or less, energy efficiency can be further improved, and pipe clogging can be more easily suppressed at a low cost.

[6] The pipe according to any one of [1] to [4],
in which the pipe cooling unit includes a jacket surrounding at least a part of an outside of the pipe, the jacket being configured to cool an inside of the pipe by allowing a cooling liquid to flow into the jacket to cool the outside of the pipe, and a refrigerant control unit for controlling the cooling liquid in the jacket such that the temperature inside the pipe is 300° C. or lower and the temperature of the upper end portion of the gasification furnace is 600° C. or higher.

In the pipe of the present disclosure, by setting the temperature inside the pipe to 300° C. or lower, pipe clogging is suppressed, and the pipe is prevented from being excessively cooled, making it possible to improve energy efficiency. In addition, by setting the temperature of the upper end portion of the gasification furnace to 600° C. or higher, the gasification reactions of the biomass raw material can proceed more easily. In particular, by employing the above-described configuration in a case of being used in a medium-scale gasification device in which the diameter of the gasification furnace exceeds 50 mm, energy efficiency can be further improved, and pipe clogging can be more easily suppressed at a low cost.

[7] A gasification system for producing a synthesis gas from a biomass raw material, including:
a biomass raw material supply device configured to supply the biomass raw material to a gasification device;
a synthesis gas production device including a gasification furnace configured to gasify the biomass raw material to produce the synthesis gas; and
a pipe through which the biomass raw material supply device and the synthesis gas production device communicate with each other,
in which the synthesis gas production device includes a gasification furnace temperature measuring unit for measuring a temperature of an upper end portion of the gasification furnace, and
the pipe includes a pipe temperature measuring unit for measuring a temperature inside the pipe and a pipe cooling unit for cooling at least a part of the pipe.

The gasification system of the present disclosure can suppress clogging using the pipe cooling unit that is excellent in handling and safe.

Additionally, since no special reagent or device is required, energy efficiency can be improved, and pipe clogging can be suppressed at a low cost.

[8] The gasification system according to [7],
in which the pipe does not have a region with a temperature exceeding 300° C. and lower than 600° C.

In the gasification system of the present disclosure, since the pipe does not have the above-described temperature region, clogging can be suppressed.

[9] The gasification system according to [7],
in which the pipe cooling unit initiates or strengthens cooling of at least a part of the pipe in a case where the temperature inside the pipe exceeds a predetermined value.

In the gasification system of the present disclosure, by initiating or strengthening cooling of at least a part of the pipe in a case where the temperature inside the pipe exceeds a predetermined value, pipe clogging is suppressed, and the pipe is prevented from being excessively cooled, making it possible to improve energy efficiency.

[10] The gasification system according to [9],
in which the predetermined value is 300° C.

In the gasification system of the present disclosure, by initiating or strengthening cooling of at least a part of the pipe in a case where the temperature inside the pipe exceeds 300° C., pipe clogging is suppressed, and the pipe is prevented from being excessively cooled, making it possible to improve energy efficiency.

[11] The gasification system according to any one of [7] to [10],
in which the pipe cooling unit includes a cooling gas supply unit for cooling an inside of the pipe by blowing a cooling gas to at least a part of an outside of the pipe to cool the outside of the pipe, and a cooling gas control unit for controlling the cooling gas such that the temperature inside the pipe is 300° C. or lower and the temperature of the upper end portion of the gasification furnace is 600° C. or higher, and
an inner diameter of the pipe is substantially the same as an inner diameter of the gasification furnace.

In the gasification system of the present disclosure, by setting the temperature inside the pipe to 300° C. or lower, pipe clogging is suppressed, and the pipe is prevented from being excessively cooled, making it possible to improve energy efficiency. In addition, by setting the temperature of the upper end portion of the gasification furnace to 600° C. or higher, the gasification reactions of the biomass raw material can proceed more easily. In particular, by employing the above-described configuration in a case of being used in a small-scale gasification device in which the diameter of the gasification furnace is 50 mm or less, energy efficiency can be further improved, and pipe clogging can be more easily suppressed at a low cost.

[12] The gasification system according to any one of [7] to [10],
in which the pipe cooling unit includes a jacket surrounding at least a part of an outside of the pipe, the jacket being configured to cool an inside of the pipe by allowing a cooling liquid to flow into the jacket to cool the outside of the pipe, and refrigerant control unit for controlling the cooling liquid in the jacket such that the temperature inside the pipe is 300° C. or lower and the temperature of the upper end portion of the gasification furnace is 600° C. or higher,
an outer diameter of the pipe is smaller than an inner diameter of the gasification furnace,
an outer diameter of the jacket is smaller than the inner diameter of the gasification furnace, and
a lower end portion of the pipe and a lower end portion of the jacket are inserted inside the gasification furnace.

In the gasification system of the present disclosure, by setting the temperature inside the pipe to 300° C. or lower, pipe clogging is suppressed, and the pipe is prevented from being excessively cooled, making it possible to improve energy efficiency. In addition, by setting the temperature of the upper end portion of the gasification furnace to 600° C. or higher, the gasification reactions of the biomass raw material can proceed more easily. In particular, by employing the above-described configuration in a case of being used in a medium-scale gasification device in which the diameter of the gasification furnace exceeds 50 mm, energy efficiency can be further improved, and pipe clogging can be more easily suppressed at a low cost.

A method for producing a synthesis gas using the gasification system according to any one of [7] to [11], including:
a cooling step of cooling the pipe.

The method for producing a synthesis gas of the present disclosure can suppress clogging using the pipe cooling unit that is excellent in handling and safe.

Additionally, since no special reagent or device is required, energy efficiency can be improved, and pipe clogging can be suppressed at a low cost. As a result, energy efficiency can be further improved, and the synthesis gas can be produced at a lower cost.

[14] The method for producing a synthesis gas according to [13],
in which the cooling step includes performing cooling such that the temperature inside the pipe is 300° C. or lower and the temperature of the upper end portion of the gasification furnace is 600° C. or higher.

In the method for producing a synthesis gas of the present disclosure, by setting the temperature inside the pipe to 300° C. or lower, pipe clogging is suppressed, and the pipe is prevented from being excessively cooled, making it possible to improve energy efficiency. In addition, by setting the temperature of the upper end portion of the gasification furnace to 600° C. or higher, the gasification reactions of the biomass raw material can proceed more easily.

[15] A fuel production system that produces a liquid fuel from a biomass raw material, including:
the gasification system according to any one of [7] to [11].

The fuel production system of the present disclosure can suppress clogging using the pipe cooling unit that is excellent in handling and safe.

Additionally, since no special reagent or device is required, energy efficiency can be improved, and pipe clogging can be suppressed at a low cost.

As a result, energy efficiency can be further improved, and the liquid fuel can be produced at a lower cost.

[16] A method for producing a liquid fuel using the fuel production system according to [15], including:
a cooling step of cooling the pipe.

The method for producing a liquid fuel of the present disclosure can suppress clogging using the pipe cooling unit that is excellent in handling and safe.

Additionally, since no special reagent or device is required, energy efficiency can be improved, and pipe clogging can be suppressed at a low cost.

As a result, energy efficiency can be further improved, and the liquid fuel can be produced at a lower cost.

[17] The method for producing a liquid fuel according to [16],
in which the cooling step includes performing cooling such that the temperature inside the pipe is 300° C. or lower and the temperature of the upper end portion of the gasification furnace is 600° C. or higher.

In the method for producing a liquid fuel of the present disclosure, by setting the temperature inside the pipe to 300° C. or lower, pipe clogging is suppressed, and the pipe is prevented from being excessively cooled, making it possible to improve energy efficiency. In addition, by setting the temperature of the upper end portion of the gasification furnace to 600° C. or higher, the gasification reactions of the biomass raw material can proceed more easily.

According to the present disclosure, it is possible to provide a pipe in a gasification system, a gasification system and a method for producing a synthesis gas using the same, and a fuel production system and a method for producing a liquid fuel using the same that are excellent in handling, safe, improve energy efficiency, and can suppress pipe clogging at a low cost.

### BRIEF DESCRIPTION OF THE DRAWINGS

FIG. 1 is a schematic diagram showing a gasification system according to an embodiment of the present disclosure.

FIG. 2 is a schematic diagram showing a part of a gasification system according to one embodiment of the present disclosure.

FIG. 3 is a schematic diagram showing a part of a gasification system according to another embodiment of the present disclosure.

FIG. 4 is a flowchart showing an outline of a pipe clogging suppression method according to the embodiment of the present disclosure.

FIG. 5 is a flowchart showing an outline of a liquid fuel production method according to the embodiment of the present disclosure.

FIG. 6 is a schematic diagram showing a fuel production system according to the embodiment of the present disclosure.

FIG. 7 is a schematic diagram showing a fuel production system according to another embodiment of the present disclosure.

FIG. 8 is a graph showing a relationship between presence or absence of clogging (raw material supply amount) and a temperature inside the pipe in Example 1,Example 2, and Comparative Example 1.

### DETAILED DESCRIPTION OF THE INVENTION

Hereinafter, embodiments of the present disclosure will be specifically described. Note that the present disclosure is not limited to the following embodiments.

### Gasification System

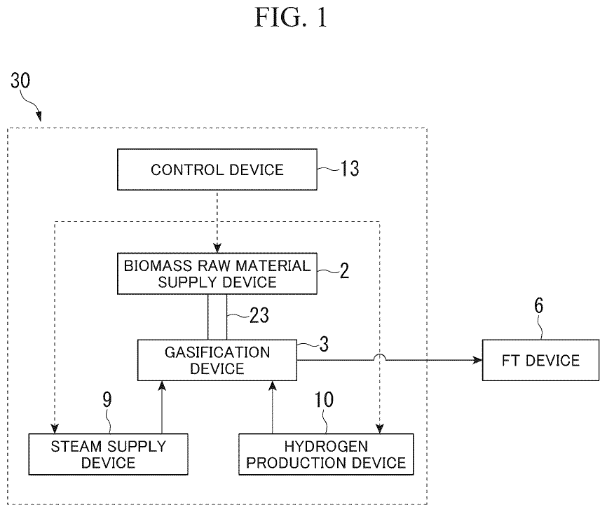

FIG. 1 is a schematic diagram showing a gasification system including a pipe according to the present embodiment. A gasification system 30 includes a biomass raw material supply device 2 that supplies a biomass raw material, a gasification device 3 that gasifies the biomass raw material supplied from the biomass raw material supply device 2 to generate a synthesis gas containing hydrogen and carbon monoxide, a pipe 23 through which the biomass raw material supply device 2 and the gasification device 3 communicate with each other, a hydrogen production device 10 that generates hydrogen to be supplied to the gasification device 3, and a steam supply device 9 that supplies steam to the gasification device 3, and uses these to produce the synthesis gas from the biomass raw material. The produced synthesis gas is supplied to the FT device 6 that produces a liquid fuel.

An inner diameter of the pipe 23 is preferably 20 to 30 mm, more preferably 23 to 28 mm, and still more preferably 25 to 26 mm.

A length of the pipe is preferably 10 to 30 cm, more preferably 15 to 25 cm, and still more preferably 20 to 20 cm.

The pipe is not particularly limited as long as it is heat-resistant, but may be made of metal, and stainless steel is particularly preferable.

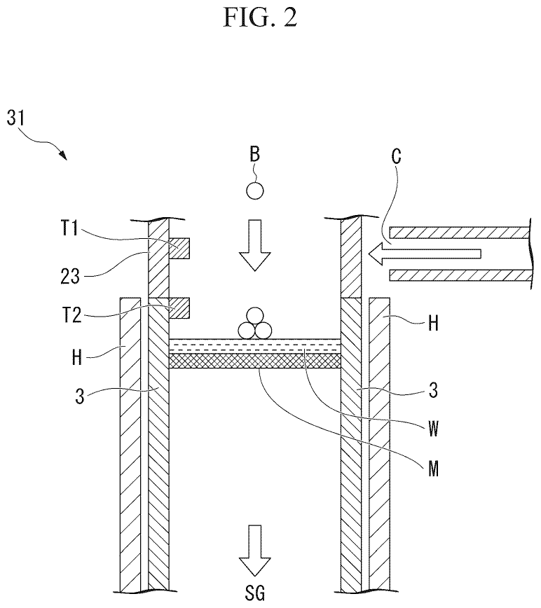

FIG. 2 is a schematic diagram showing a part of a gasification system according to the present embodiment. A gasification system 31 includes the biomass raw material supply device 2 (not shown), the gasification device 3 containing a gasification furnace, the pipe 23 through which the biomass raw material supply device 2 and the gasification device 3 communicate with each other, a cooling gas inlet C for cooling an inside of the pipe, a temperature measuring unit T1 for measuring a temperature of a pipe interior region facing a region where a cooling gas is blown, a heating device H for heating a gasification furnace of the gasification device 3, and a temperature measuring unit T2 for measuring a temperature of an upper end portion of the gasification furnace, and uses these to produce a synthesis gas SG from a biomass raw material B.

As shown in FIG. 2, the inner diameter of the pipe 23 and the inner diameter of the gasification furnace are substantially the same. For example, the inner diameter of the pipe 23 and the inner diameter of the gasification furnace may be 20 to 30 mm.

A position and a size of the cooling gas inlet C are not particularly limited as long as the pipe can be cooled to 300° C. or lower, but the cooling gas inlet C may be provided, for example, in a region of 10 to 20 mm from the upper end portion of the gasification furnace. The cooling gas inlet C may be formed by disposing a cylindrical pipe having an inner diameter of 5 to 10 mm to be spaced apart from a side surface of the pipe without communicating with the inside of the pipe.

A type and a temperature of the cooling gas are not particularly limited as long as the pipe can be cooled to 300° C. or lower, but the cooling gas may be, for example, air or an inert gas such as nitrogen. The temperature of the cooling gas is not particularly limited as long as the pipe can be cooled to 300° C. or lower, but may be, for example, 40° C. or lower, 30° C. or lower, or room temperature. As shown in FIG. 2, it is preferable that the heating device H heats up to the upper end portion of the gasification furnace and does not heat the pipe 23 from the viewpoint of cooling efficiency. In the present specification, the upper end portion of the gasification furnace unit a region within 5 mm from an upper end surface of the gasification furnace.

As shown in FIG. 2, a metal mesh M and silica wool W for fixing the supplied biomass raw material B in the gasification furnace may be provided inside the gasification furnace.

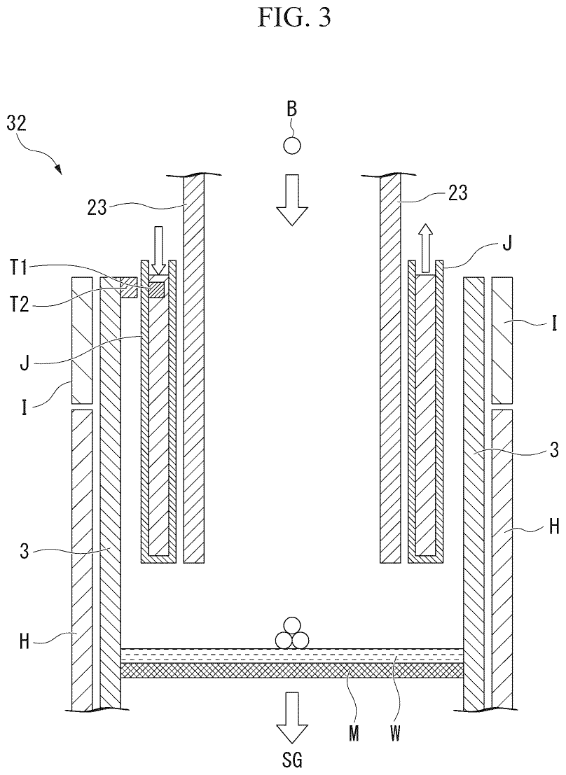

FIG. 3 is a schematic diagram showing a part of a gasification system according to another embodiment. A gasification system 32 includes the biomass raw material supply device 2 (not shown), the gasification device 3 containing a gasification furnace, the pipe 23 through which the biomass raw material supply device 2 and the gasification device 3 communicate with each other, a jacket J that is attached to an outside of the pipe to cool the pipe from the outside, a temperature measuring unit T1 for measuring a temperature inside the pipe, a heating device H for heating the gasification furnace of the gasification device 3, and a temperature measuring unit T2 for measuring the temperature of the upper end portion of the gasification furnace, and uses these to produce the synthesis gas SG from the biomass raw material B.

As shown in FIG. 3, an outer diameter of the pipe 23 is smaller than an inner diameter of the gasification furnace, an outer diameter of the jacket J is smaller than the inner diameter of the gasification furnace, and a lower end portion of the pipe 23 and a lower end portion of the jacket J are inserted inside the gasification furnace. For example, the inner diameter of the pipe 23 may be 20 to 30 mm. The inner diameter of the gasification furnace may be 70 to 110 mm or 80 to 100 mm. The inner diameter of the jacket is not particularly limited as long as the jacket can be attached to the pipe 23, but may be, for example, 22 to 32 mm.

A position and a size of the jacket J are not particularly limited as long as the pipe can be cooled to 300° C. or lower, but the jacket J may have, for example, a thickness of 3 mm or less and a length of 10 to 20 cm. The temperature of a cooling liquid flowing inside the jacket J is not particularly limited as long as the pipe can be cooled to 300° C. or lower, but may be, for example, −20° C. to 0° C. or −15° C. to −5° C. Examples of the cooling liquid include ethylene glycol and a mixed solvent of ethylene glycol and water.

As shown in FIG. 3, the temperature measuring unit T1 may be a unit for measuring the temperature of the cooling liquid flowing in the jacket and confirming the temperature inside the pipe from the measured temperature.

As shown in FIG. 3, the heating device H heats the lower end portion of the pipe 23 and the lower end portion of the jacket J, which are inserted inside the gasification furnace.

As shown in FIG. 3, the metal mesh M and the silica wool W for fixing the supplied biomass raw material B in the gasification furnace may be provided inside the gasification furnace.

As shown in FIG. 3, an insulating material I for maintaining the temperature of the jacket J may be provided upstream of the gasification furnace and the heating device H. By providing the insulating material I, the temperature at the position where the insulating material I is provided can be maintained at the same temperature as the temperature at the position heated by the heating device H.

As shown in FIG. 3, the temperature measuring unit T2 may measure the temperature of an upper end portion of the insulating material I.

### Pipe Clogging Suppression Method

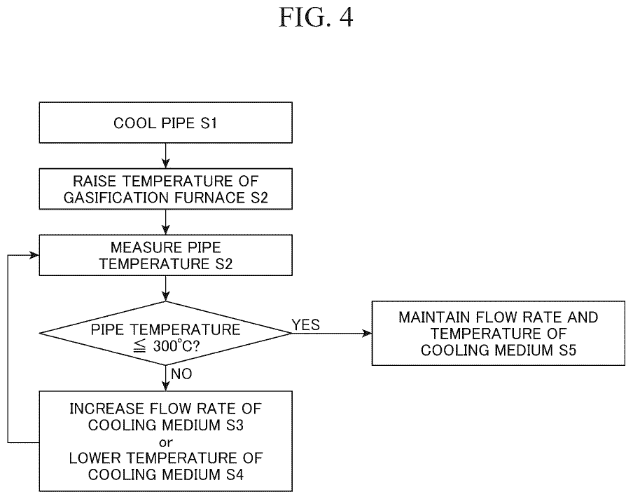

FIG. 4 is a flowchart showing an outline of a pipe clogging suppression method according to the present embodiment. First, the control device cools the inside of the pipe such that the temperature inside the pipe is in a normal state, that is, 300° C. or lower, based on a detection signal of a temperature sensor that measures the temperature inside the pipe (S1).

Next, the control device raises the temperature of the gasification furnace such that the temperature of the upper end portion of the gasification furnace is in a normal state, that is, 600° C. or higher, based on a detection signal of a temperature sensor that measures the temperature of the upper end portion of the gasification furnace (S2).

Subsequently, the control device measures the temperature inside the pipe (S3) and determines whether or not the temperature inside the pipe is in a normal state, that is, 300° C. or lower. In a case where the determination result is YES, the control device controls cooling unit to maintain the temperature inside the pipe in a normal state, that is, at 300° C. or lower (S5). In a case where the determination result is NO, the cooling unit is controlled by lowering the temperature of the cooling unit such that the temperature inside the pipe is in a normal state, that is, 300° C. or lower, increasing the flow rate of the cooling gas (S3) or a cooling medium in the cooling unit (S4), or the like.

As described above, in the pipe clogging suppression method shown in FIG. 4, the cooling unit is controlled to lower the temperature inside the pipe in a case where the temperature inside the pipe is 300° C. or higher, and the cooling unit is controlled to maintain the temperature inside the pipe in a case where the temperature inside the pipe is 300° C. or lower. As a result, pipe clogging is suppressed, and the pipe is prevented from being excessively cooled, making it possible to improve energy efficiency.

### Fuel Production Method

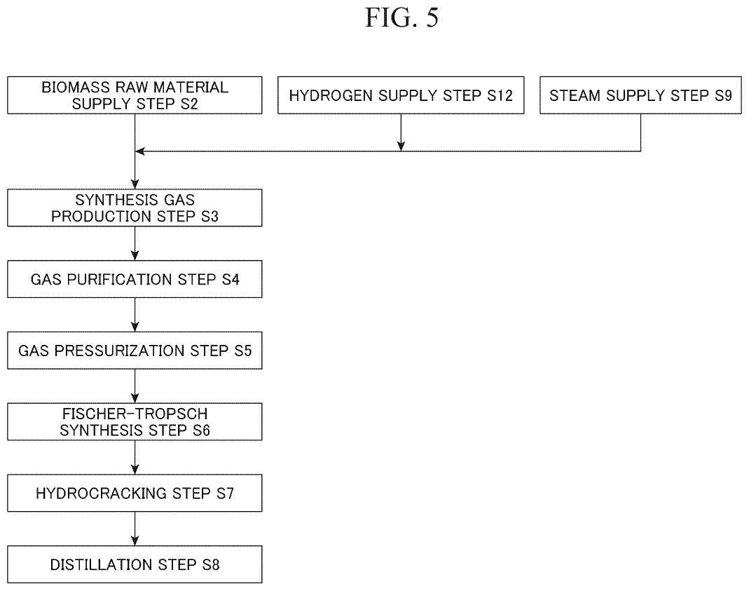

FIG. 5 is a flowchart showing a configuration of a fuel production method according to the present embodiment.

As shown in FIG. 5, the fuel production method according to the embodiment includes a biomass raw material supply step S2 of supplying the biomass raw material to the gasification furnace for producing the synthesis gas, a hydrogen supply step S12 of supplying hydrogen to the gasification furnace, a steam supply step S9 of supplying steam to the gasification furnace, a synthesis gas production step S3 of reacting the biomass raw material, hydrogen, steam, and the like to produce a synthesis gas containing hydrogen and carbon monoxide, a Fischer-Tropsch synthesis step S6 of subjecting the generated synthesis gas to a Fischer-Tropsch synthesis reaction to produce a Fischer-Tropsch oil, a hydrocracking step S7 of subjecting a heavy fraction (generally, C₂₁ or more) contained in the Fischer-Tropsch oil to hydrocracking using hydrogen to reduce the carbon number to C₂₀ or less, and a distillation step S8 of distilling the Fischer-Tropsch oil after hydrocracking to separate a liquid fuel and the FT off-gas.

In the biomass raw material supply step S2, a predetermined pretreatment is performed on the biomass raw material such as rice husks, bagasse, and wood, and the biomass raw material subjected to the pretreatment is supplied to the gasification furnace of a gasification device that performs the synthesis gas production step S3 via a raw material supply path. Here, the pretreatment for the biomass raw material includes, for example, a drying step of drying the raw material, a grinding step of grinding the raw material, and the like.

In the hydrogen supply step S12, hydrogen is supplied to the gasification furnace of the gasification device. Hydrogen may be supplied by, for example, generating hydrogen through electrolysis of water.

In the steam supply step S9, steam is supplied to the gasification furnace of the gasification device. The temperature of steam is preferably 500° C. or higher.

In the synthesis gas production step S3, the biomass raw material, hydrogen, carbon monoxide, and carbon dioxide are reacted to produce the synthesis gas containing hydrogen and carbon monoxide.

When hydrogen, carbon monoxide, and carbon dioxide are fed into the gasification furnace into which the biomass raw material has been fed, for example, a total of eight types of gasification reactions and reverse reactions thereof, as shown in Formulas (1-1) to (1-8), proceed in the gasification furnace, and the synthesis gas containing hydrogen, carbon monoxide, carbon dioxide, and hydrocarbons is generated.

C+H₂O [symbol] CO+H₂ (1-1)

C+CO₂ [symbol] 2CO (1-2)

C+2H₂ [symbol] CH₄ (1-3)

C+2H₂O [symbol] CO₂+2H₂ (1-4)

CO+H₂O [symbol] CO₂+H₂ (1-5)

2CO+2H₂ [symbol] CO₂+CH₄ (1-6)

CO+3H₂ [symbol] H₂O+CH₄ (1-7)

CO₂+4H₂ [symbol] 2H₂O+CH₄ (1-8)

CH₄+H₂O [symbol] CO+3H₂ (1-9)

The gasification of the biomass raw material is preferably performed at 850° C. or higher and more preferably at 900° C. or higher. When the temperature of gasification is equal to or higher than the above-described lower limit value, the biomass raw material is more easily gasified. Gasification temperature is preferably 2000° C. or lower, and more preferably 1500° C. or less.

Hereinafter, a fuel production system according to one embodiment of the present disclosure will be described with reference to the drawings.

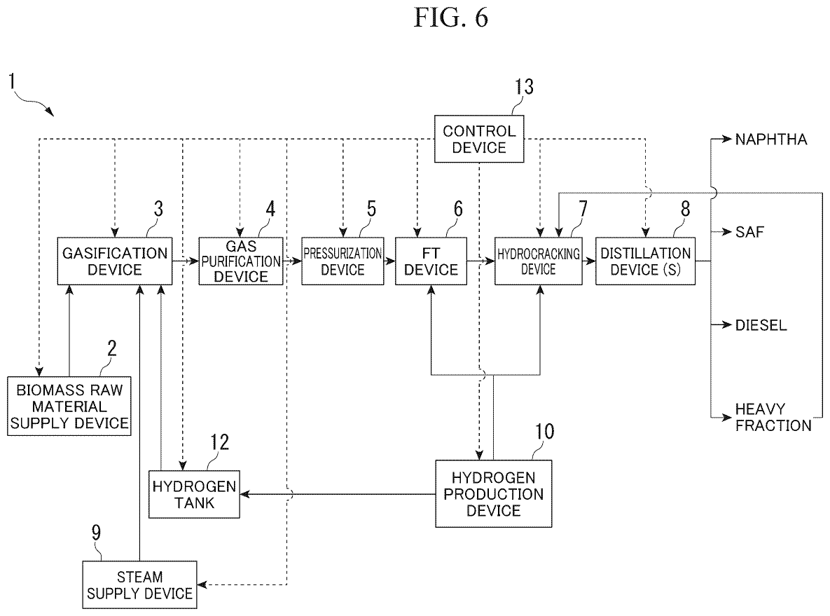

FIG. 6 is a diagram showing a configuration of a fuel production system 1 according to the present embodiment. The fuel production system 1 includes the biomass raw material supply device 2 that supplies the biomass raw material, the gasification device 3 that gasifies the biomass raw material supplied from the biomass raw material supply device 2 to generate the synthesis gas containing hydrogen and carbon monoxide, the FT device 6 that produces the liquid fuel from the synthesis gas supplied from the gasification device 3, the hydrogen production device 10 that generates hydrogen, the steam supply device 9 that supplies steam, a hydrogen tank 12 that stores hydrogen generated by the hydrogen production device 10, and the control device 13 that controls these, and uses these to produce the liquid fuel from the biomass raw material.

The biomass raw material supply device 2 performs a predetermined pretreatment on the biomass raw material such as rice husks, bagasse, and wood and supplies the biomass raw material subjected to the pretreatment to the gasification furnace of the gasification device 3 via the raw material supply path. Here, the pretreatment for the biomass raw material includes, for example, a drying step of drying the raw material, a grinding step of grinding the raw material, and the like.

A method for supplying the biomass raw material to the gasification furnace is not particularly limited, and a known supply method can be employed.

The gasification device 3 may include the gasification furnace for gasifying the biomass raw material supplied via the raw material supply path, a gasification furnace sensor group composed of a plurality of sensors that detect a state inside the gasification furnace, a steam supply device that supplies steam into the gasification furnace, an oxygen supply device that supplies oxygen into the gasification furnace, a heating device that heats the gasification furnace, a scrubber that cleans the synthesis gas discharged from the gasification furnace, and a desulfurization device that removes a sulfur component from the synthesis gas cleaned by the scrubber and that supplies the synthesis gas to the FT device 6.

The reaction conditions in the synthesis gas production are not particularly limited, and known reaction conditions can be employed.

The steam supply device 9 vaporizes water stored in a water tank (not shown) and supplies the vaporized water into the gasification furnace. The heating device consumes fuel supplied from a fuel tank (not shown) or electric power supplied from a power supply (not shown) to heat the gasification furnace. The control device 13 controls a steam supply amount from the steam supply device to the gasification furnace and an input heat amount from the heating device to the gasification furnace. In the fuel production system 1 according to the present embodiment, by supplying hydrogen from the hydrogen production device 10 to be described below into the gasification furnace or the raw material supply path, it may not be necessary to actively supply steam from the steam supply device into the gasification furnace. In this case, the steam supply device can also be removed from the fuel production system 1.

A method for producing and supplying steam is not particularly limited, and a known production and supply method can be employed. A method for heating the gasification furnace is not particularly limited, and a known heating method can be employed.

When water, hydrogen, heat, and the like are fed into the gasification furnace into which the biomass raw material has been fed, by the steam supply device, the hydrogen production device, and the heating device, in the gasification furnace, for example, a total of eight types of gasification reactions and reverse reactions thereof, as shown in Formulas (1-1) to (1-8), proceed, and the synthesis gas containing hydrogen, carbon monoxide, carbon dioxide, and hydrocarbons is generated.

The gasification furnace sensor group includes, for example, a pressure sensor that detects a pressure in the gasification furnace, a temperature sensor that detects a temperature in the gasification furnace, an H₂/CO sensor that detects an H₂/CO ratio of the synthesis gas that corresponds to a ratio of hydrogen to carbon monoxide in the gasification furnace, a CO₂ sensor that detects carbon dioxide in the gasification furnace, and the like. Detection signals of these sensors constituting the gasification furnace sensor group are transmitted to the control device 13.

The hydrogen production device 10 includes an electrolytic device (not shown) and generates hydrogen using electric power. The device that generates hydrogen using electric power is not particularly limited, and a known device can be employed. Examples thereof include a device that generates hydrogen through electrolysis of water.

The hydrogen tank 12 stores hydrogen generated by the hydrogen production device 10. Hydrogen is supplied from the hydrogen tank 12 to the gasification device 3. The hydrogen tank is not particularly limited, and a known tank can be employed. Examples thereof include a pressure-resistant tank. The hydrogen tank may be made of metal or resin.

A hydrogen supply pump (not shown) may be provided as a hydrogen supply unit for supplying hydrogen from the hydrogen tank 12 to the gasification device 3. The hydrogen supply pump supplies hydrogen stored in the hydrogen tank 12 into the gasification furnace of the gasification device 3. The hydrogen supply amount from the hydrogen supply pump to the gasification furnace is controlled by the control device 13. In the fuel production system 1 according to the present embodiment, a case where hydrogen stored in the hydrogen tank 12 is supplied into the gasification furnace by the hydrogen supply pump will be described, but the present disclosure is not limited thereto. The hydrogen stored in the hydrogen tank 12 may be supplied upstream of the gasification furnace, more specifically, into the raw material supply path of the biomass raw material.

The control device 13 is a computer that controls the steam supply amount from the steam supply device, the input heat amount from the heating device, the hydrogen generation amount from the electrolytic device, the hydrogen filling amount from the hydrogen filling pump, the hydrogen supply amount from the hydrogen supply pump, and the like based on the detection signals from the gasification furnace sensor group, the detection signal from the pressure sensor of the hydrogen tank 12, and the like.

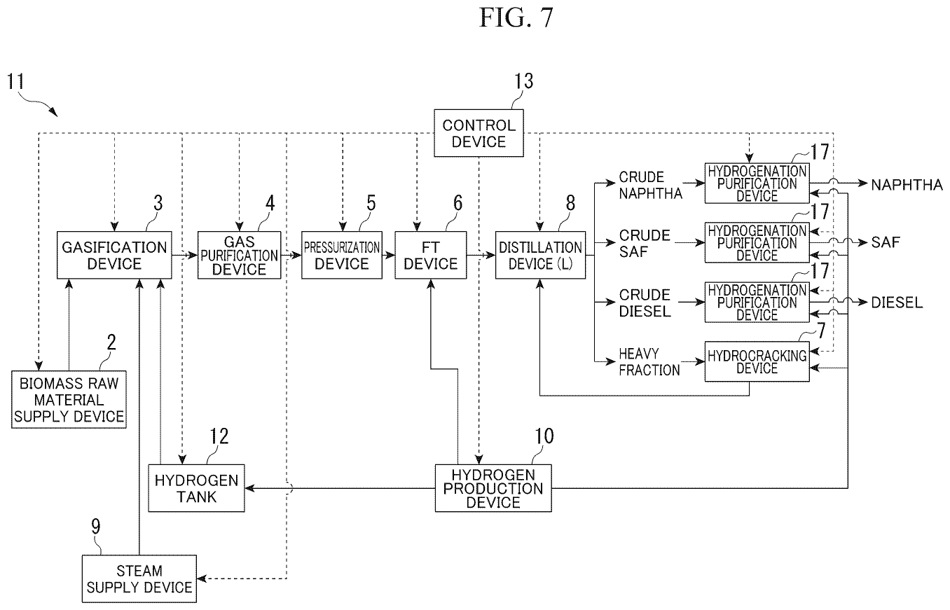

FIG. 7 is a diagram showing a configuration of a fuel production system 11 according to another embodiment. The configuration is the same as that in FIG. 6 except that the order of a distillation device (L) 8 and a hydrocracking device 7 is changed and a hydrogenation purification device 17 is provided downstream of the distillation device (L) 8.

One embodiment of the present disclosure has been described above, but the present disclosure is not limited thereto. The detailed configuration may be appropriately changed within the scope of the gist of the present disclosure.

### EXAMPLES

Hereinafter, the present disclosure will be described in more detail with reference to examples, but the present disclosure is not limited to the following examples.

### Example 1

Using the gasification system shown in FIG. 2, the cooling gas was blown to the outside of the pipe to cool the inside of the pipe such that the temperature inside the pipe was 170° C., the biomass raw material was supplied to the gasification furnace while the gasification furnace was heated such that the temperature at the upper end portion of the gasification furnace was 600° C. or higher, and the presence or absence of the clogging in the pipe was confirmed. The results are shown in Table 1.

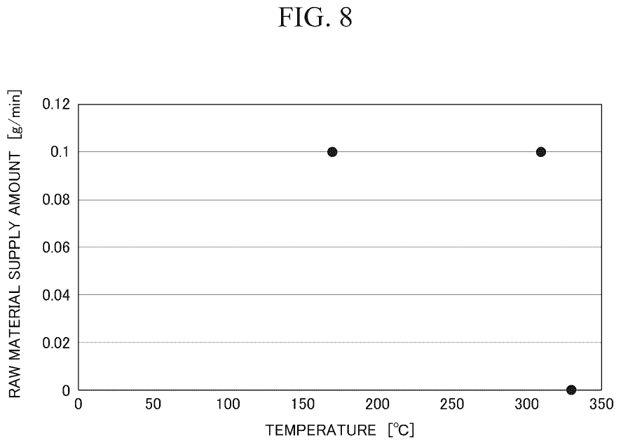

Additionally, FIG. 8 shows the amount of the biomass raw material that could be supplied to the gasification furnace.

### Example 2 and Comparative Example 1

Using the gasification system shown in FIG. 2, the biomass raw material was supplied to the gasification furnace in the same manner as in Example 1, except that the cooling gas was blown to the outside of the pipe to cool the inside of the pipe such that the temperatures inside the pipe were temperatures shown in Table 1, and the presence or absence of the clogging in the pipe was confirmed. The results are shown in Table 1. Additionally, FIG. 8 shows the amount of the biomass raw material that could be supplied to the gasification furnace.

TABLE 1

Temperature inside pipe
[° C.]

| | 170 | 309 | 330 |
|---|---|---|---|
| Presence or absence of | None | None | Present |
| clogging | | | |

As shown in Table 1, in both Examples 1 and 2 in which the temperatures inside the pipe were 170° C. and 309° C., the pipe clogging could be suppressed. In addition, as shown in FIG. 8, a decrease in the supply amount of the biomass due to the pipe clogging was not observed.

On the other hand, in Comparative Example 1 in which the temperature inside the pipe was 330° C., the pipe clogging could not be suppressed. Moreover, as shown in FIG. 8, clogging of the pipe resulted in the inability to supply the biomass.

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

### EXPLANATION OF REFERENCES

1, 11: fuel production system
2: biomass raw material supply device
3: gasification device
4: gas purification device
5: gas pressurization device
6: Fischer-Tropsch device (FT device)
7: hydrocracking device
8: distillation device
9: steam supply device
10: hydrogen production device
12: hydrogen tank
13: control device
17: hydrogenation purification device
30: gasification system
23: pipe

What is claimed is:

1. A pipe through which a biomass raw material supply device configured to supply a biomass raw material to a gasification device and a synthesis gas production device including a gasification furnace configured to gasify the biomass raw material to produce a synthesis gas communicate with each other, the synthesis gas production device including a gasification furnace temperature measuring unit for measuring a temperature of an upper end portion of the gasification furnace, the pipe comprising:
a pipe temperature measuring unit for measuring a temperature inside the pipe; and
a pipe cooling unit for cooling at least a part of the pipe.

2. The pipe according to claim 1,
wherein the pipe does not have a region with a temperature exceeding 300° C. and lower than 600° C.

3. The pipe according to claim 1,
wherein the pipe cooling unit initiates or strengthens cooling of at least a part of the pipe in a case where the temperature inside the pipe exceeds a predetermined value.

4. The pipe according to claim 3,
wherein the predetermined value is 300° C.

5. The pipe according to claim 1,
wherein the pipe cooling unit includes a cooling gas supply unit for cooling an inside of the pipe by blowing a cooling gas to at least a part of an outside of the pipe to cool the outside of the pipe, and a cooling gas control unit for controlling the cooling gas such that the temperature inside the pipe is 300° C. or lower and the temperature of the upper end portion of the gasification furnace is 600° C. or higher.

6. The pipe according to claim 1,
wherein the pipe cooling unit includes a jacket surrounding at least a part of an outside of the pipe, the jacket being configured to cool an inside of the pipe by allowing a cooling liquid to flow into the jacket to cool the outside of the pipe, and a refrigerant control unit for controlling the cooling liquid in the jacket such that the temperature inside the pipe is 300° C. or lower and the temperature of the upper end portion of the gasification furnace is 600° C. or higher.

7. A gasification system for producing a synthesis gas from a biomass raw material, comprising:
a biomass raw material supply device configured to supply the biomass raw material to a gasification device;
a synthesis gas production device including a gasification furnace configured to gasify the biomass raw material to produce the synthesis gas; and
a pipe through which the biomass raw material supply device and the synthesis gas production device communicate with each other,
wherein the synthesis gas production device includes a gasification furnace temperature measuring unit for measuring a temperature of an upper end portion of the gasification furnace, and
the pipe includes a pipe temperature measuring unit for measuring a temperature inside the pipe and a pipe cooling unit for cooling at least a part of the pipe.

8. The gasification system according to claim 7,
wherein the pipe does not have a region with a temperature exceeding 300° C. and lower than 600° C.

9. The gasification system according to claim 7,
wherein the pipe cooling unit initiates or strengthens cooling of at least a part of the pipe in a case where the temperature inside the pipe exceeds a predetermined value.

10. The gasification system according to claim 9,
wherein the predetermined value is 300° C.

11. The gasification system according to claim 7,
wherein the pipe cooling unit includes a cooling gas supply unit for cooling an inside of the pipe by blowing a cooling gas to at least a part of an outside of the pipe to cool the outside of the pipe, and a cooling gas control unit for controlling the cooling gas such that the temperature inside the pipe is 300° C. or lower and the temperature of the upper end portion of the gasification furnace is 600° C. or higher, and
an inner diameter of the pipe is substantially the same as an inner diameter of the gasification furnace.

12. The gasification system according to claim 7,
wherein the pipe cooling unit includes a jacket surrounding at least a part of an outside of the pipe, the jacket being configured to cool an inside of the pipe by allowing a cooling liquid to flow into the jacket to cool the outside of the pipe, and a refrigerant control unit for controlling the cooling liquid in the jacket such that the temperature inside the pipe is 300° C. or lower and the temperature of the upper end portion of the gasification furnace is 600° C. or higher,
an outer diameter of the pipe is smaller than an inner diameter of the gasification furnace,
an outer diameter of the jacket is smaller than the inner diameter of the gasification furnace, and
a lower end portion of the pipe and a lower end portion of the jacket are inserted inside the gasification furnace.

13. A method for producing a synthesis gas using the gasification system according to claim 7, comprising:
a cooling step of cooling the pipe.

14. The method for producing a synthesis gas according to claim 13,
wherein the cooling step includes performing cooling such that the temperature inside the pipe is 300° C. or lower and the temperature of the upper end portion of the gasification furnace is 600° C. or higher.

15. A fuel production system that produces a liquid fuel from a biomass raw material, comprising:
the gasification system according to claim 7.

16. A method for producing a liquid fuel using the fuel production system according to claim 15, comprising:
a cooling step of cooling the pipe.

17. The method for producing a liquid fuel according to claim 16,
wherein the cooling step includes performing cooling such that the temperature inside the pipe is 300° C. or lower and the temperature of the upper end portion of the gasification furnace is 600° C. or higher.

18. A method for using a pipe of claim 1, comprising:
connecting a biomass raw material supply device configured to supply a biomass raw material to a gasification device and a synthesis gas production device including a gasification furnace configured to gasify the biomass raw material to produce a synthesis gas with each other through the pipe.

18. he method for using a pipe of claim 18, further comprising
initiating or strengthening cooling of at least a part of the pipe in a case where the temperature inside the pipe exceeds 300° C.

20. The method for using a pipe of claim 18, further comprising
cooling an inside of the pipe by blowing a cooling gas to at least a part of an outside of the pipe to cool the outside of the pipe in a case where the temperature inside the pipe exceeds 300° C.

21. The method for using a pipe of claim 18, further comprising
cooling an inside of the pipe by allowing a cooling liquid to flow into a jacket to cool the outside of the pipe, wherein
the jacket surrounds at least a part of an outside of the pipe.
